(19) United States
(12) Patent Application Publication
(10) Pub. No.: US 2003/0168623 A1
(43) Pub. Date: Sep. 11, 2003

(54) Sliding valve for a hydraulic dashpot

(76) Inventor: Lennart Askevold, Sterling Heights, MI (US)

Correspondence Address: Dr. Max Fogiel, 61 Ethel Road West, Piscataway, NJ, 08854, US

(21) Appl. No.: 10/369,913

(22) Filed: Feb. 20, 2003

(30) Foreign Application Priority Data
Mar. 2, 2002 (DE) 102 09 367.9-12

(51) Int. Cl. F16K 39/00

(52) U.S. Cl. 251/282

(57) ABSTRACT

A sliding valve for the bypass-valve assembly in a hydraulic dashpot, with a shaft and a flange that fits into a round sealing edge surrounding a cutout with ports (bores) extending through to its back. The object is to decrease the suction caused by the suction caused by rapid flow against the sealing edge. The ports (26) through the flange (17) are accordingly as wide as possible, leaving only webs (25) between the sealing edge (12) and the shaft (16).

The present invention concerns a sliding valve for a bypass valve assembly in a hydraulic dashpot as recited in the preamble to claim 1 herein.

Sliding valves of this genus are generally known, and a great many versions are manufactured and employed. One example is described in German 3 535 287 A1. This valve opens more or less wide subject to an electromagnet and against the force of a helical spring. The valve seat is flat and operates in conjunction with a round and knife-sharp sealing edge that surrounds a cutout. Ports breaching to the rear of the valve allow hydraulic-pressure equilibration.

The generic sliding valves almost all operate with a vary narrow gap between the sealing edge and the valve seat. At wide differences in pressure, accordingly, the fluid will flow rapidly and generate a powerful suction even inside the cutout that will tend to close the valve. This force must be counteracted by the magnet, which makes the valve difficult to control as well as demanding more electricity.

The object of the present invention is accordingly to diminish the suction on the sliding valve generated by the rapidly flowing fluid at the sealing edge.

This object is attained in accordance with the present invention in a sliding valve of the aforesaid genus by the characteristics recited in the body of claim 1. claims 2 and 3 address practical alternative and advanced embodiments.

The particular advantage of the present invention is the diminishment of the suction that attracts the sliding valve. Another advantage is that the valve can be smaller, which decreases its inertia and facilitates control.

One embodiment of the present invention will now be specified with reference to the accompanying drawing, wherein

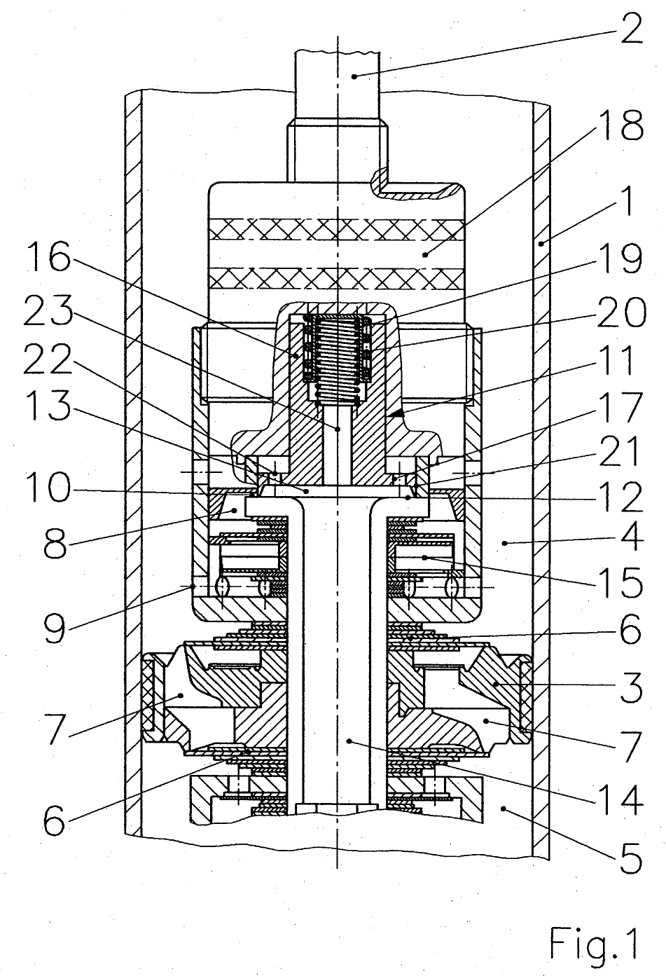

FIG. 1 illustrates a bypass-valve assembly with a state-of the-art sliding valve,

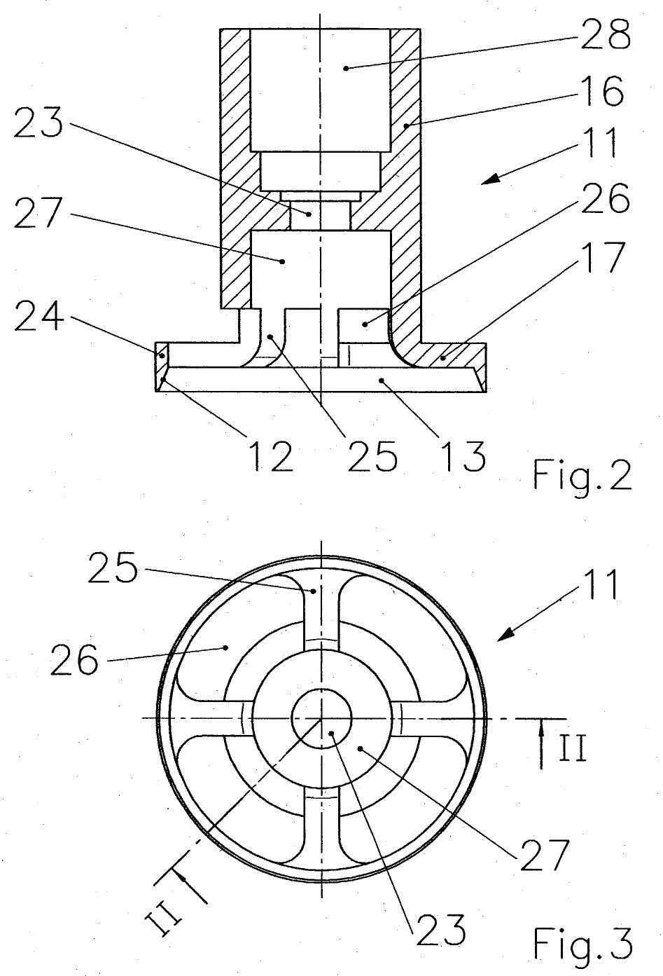

FIG. 2 a section through a sliding valve in accordance with the present invention, and

FIG. 3 an overhead view of the valve illustrated in FIG. 2.

Hydraulic dashpots like the device illustrated in FIG. 1 for example are usually provided with a cylinder 1 charged with shock-absorbing fluid. A piston 3 mounted on a piston rod 2 divides the cylinder into two chambers 4 and 5 and travels up and down inside it. Piston 3 is breached by ports 7 capped by cupsprings 6 and as a whole attenuating the flow of fluid back and forth between chambers 4 and 5. For special applications, a bypass is introduced paralleling ports 7 that can be opened and closed either entirely or gradually by a valve. The bypass and valve in the illustrated example are accommodated between piston 3 and piston rod 2. Other locations, inside the dashpot itself, especially in the vicinity of the base valve for example, or outside it and communicating with chambers 4 and 5 by way of channels, also possible.

The bypass in the illustrated example is provided with annular channels 8 that communicate with upper chamber 4 and terminate as radial slots 10 in the outer circumference of a sliding valve 11. Valve 11 is provided with a knife-sharp sealing edge 12 surrounding a cutout 13. Cutout 13 communicates hydraulically with lower chamber 5 through a central bore 14. As sliding valve 11 lifts, it releases the hydraulic path through the bypass by way of an intake bore 9, an annular channel 8, a radial slot 10, cutout 13, and bore 14. This route also includes an upstream valve 15 in the illustrated example.

Valve 11 is provided with a hollow shaft 16 and a flange 17, the two comprising an integrated component in the illustrated embodiment. A sliding valve of this species can be sintered out of a magnetizable material.

An electromagnet 18 is actuated and attracts valve 11 against the force of one or, as in the illustrated embodiment, two helical springs 19 and 20, accordingly lifting sealing edge 12 more or less off a, flat in the present example, valve seat 21, releasing the bypass channel to the same extent.

To ensure reliable control, the back of the sliding valve is relieved of hydraulic pressure by way of bores 22 extending through flange 17 and of another bore 23 through the center of shaft 16.

A state-of-the-art sliding valve like the one illustrated in FIG. 1 entails the drawback that the fluid will flow too rapidly between sealing edge 12 and valve seat 21 when the difference in pressure between chambers 4 and 5 is too wide and the opening in the valve too narrow. The result is a powerful suction not only below sealing edge 12 but also within cutout 13. This suction can even be powerful enough to cause cavitation. The highly variable flow accompanied by turbulence and cavitation in cutout 13 prevents the suction from being reliably transmitted through bores 22 and to the back of flange 17 and to the back of shaft 16 as well because the suction in the central bore will already have adjusted itself.

The aforesaid problems at the state of the art are considerably alleviated by the sliding valves in accordance with the present invention illustrated in FIGS. 2 and 3. FIG. 2 is a section along the line II-II in FIG. 3 through such a sliding valve. Sliding valve 11 is again preferably sintered and provided with an integrated shaft 16 and flange 17. Sealing edge 12 extends down from the circumference of flange 17 and up therefrom in the form of a ring 24. Ring 24 is connected to shaft 16 only by webs 25, leaving large kidney-shaped ports 26 through flange 17. Webs 25 extend farther axially down from the bottom of shaft 16 with the kidney-shaped ports between them. The bottom of shaft 16 accommodates a bore 27 that is as wide as possible and the shaft assumes in this vicinity the form of a hollow cylinder with a very thin wall. The usual ports 26 that accommodate helical springs 19 and 20 are provided at the top of shaft 16.

The valve 11 in accordance with the present invention provides enough space for the turbulence to prevent it from too powerfully attracting the inner surface of cutout 13. The large kidney-shaped ports 26 ensure that the suction resulting from the turbulence will be reliably transmitted to the back of flange 17, whereby the extent of that surface can be dictated only by the thickness of webs 25 and by that of ring 24, so that only a slight differential force can occur.

The wide bore 27 through shaft 16 improves the turbulence situation here as well. The short path between bore 23 decreases flow impedance and reduces the difference in pressure between the back and front of shaft [sic] 13.

List of Parts

```
  1. cylinder
  2. piston rod
  3. piston
  4. upper chamber
  5. lower chamber
  6. cupspring
  7. port
  8. annular channel
  9. intake bore
10. radial slot
11. sliding valve
12. sealing edge
13. cutout
14. bore
15. upstream valve
16. shaft
17. flange
18. coil
19. spring
20. spring
21. valve seat
22. bore
23. bore
24. ring
25. web
26. port
27. bore
28. bore
```

1. Sliding valve for the bypass-valve assembly in a hydraulic dashpot, with a shaft and a flange that fits into a round sealing edge surrounding a cutout with ports (bores) extending through to its back, characterized in that the ports (26) through the flange (17) are as wide as possible, leaving only webs (25) between the sealing edge (12) and the shaft (16).

2. Sliding valve as in claim 1, characterized in that the ports (26) and webs (25) extend into the shaft (16).

3. Sliding valve as in claim 1 or 2, characterized in that the cutout (13) extends into the shaft (16) where it assumes the form of a thin-walled cylinder.
